(19) United States
(12) Patent Application Publication
(10) Pub. No.: US 2015/0045914 A1
(43) Pub. Date: Feb. 12, 2015

(54) Apparatus and Method of Configuring and/or Programming a Safety Control

(71) Applicant: SICK AG, Waldkirch (DE)

(72) Inventors: Markus SAUMER, Waldkirch (DE); Klaus WEDDINGFELD, Waldkirch (DE)

(21) Appl. No.: 14/336,278

(22) Filed: Jul. 21, 2014

(30) Foreign Application Priority Data
Aug. 9, 2013 (EP) 13179809.2

(51) Int. Cl. G05B 19/042

(52) U.S. Cl. CPC G05B 19/0428; G05B 2219/24015
USPC 700/79

(57) ABSTRACT

In order to guard against a possible erroneous configuration and/or programming of a safety control an apparatus for configuring and/or programming a safety control having a display for displaying a program part of the safety control in the form of a block diagram is provided in accordance with the invention, wherein individual blocks represent program elements, a memory unity having at least one processing element, in particular a logic link and/or a function and having both safety related as well as non-safety related communication elements which in particular form input signals and output signals and having a calculation unit for selecting the processing and communication elements in the memory unit and for the generation of a link of the selected processing and communication elements in the block diagram indicated in the display, wherein the calculation unit is configured in such a way that a communication element characterized as a non-safety related communication element results at an output side of the processing element when on a link of a safety related communication element to a non-safety related communication element which are present at an input side of the processing element is made.

The present invention relates to an apparatus for configuring and/or programming a safety control and to a method of configuring and/or programming the same.

In today's automatization of processing centers, in particular of industrial plants the requirement on a secure monitoring and a secure reaction to a situation of danger is constantly increasing in order to protect the staff at the processing centers and to ensure a high operational safety.

Safety controls serve this purpose, the safety controls monitor the processing centers and react in an error-free manner in a predefined kind on the presence of a danger signal. Such a known application is the securing of dangerous work machines, such as, for example automation cells, in particular robot work cells, presses or the like, which have to be switched off immediately or have to be brought into a safe state when operating staff approaches the work machines in an unallowed manner or are present in their regions of movement. In order to recognize the situation of danger the safety control receives signals from associated sensors, such as e.g. a light barrier, a light grid, a camera or the like, the signals are evaluated by the safety control and a corresponding safety reaction is initiated by the safety control.

Through the possibility of changing the processing centers by expanding this with additional automation cells or by replacing the automation cells with other different kinds of automation cells, a likewise high flexibility with regard to the possibility of expansion having regard to a safety control is expected which has to be newly configured and programmed in accordance with the changed processing center.

In accordance with the invention the selection of elements which belong to the safety control, such as e.g. control modules, input modules and/or output modules, sensors, actors or the like, as well as their physical arrangement and connection and/or cabling is understood as configuration. Programming is understood as the automatic generation and linking of corresponding program parts corresponding to the configuration on a consideration of logic evaluation rules on the basis of user inputs, the logic evaluation rules connecting the elements selected on the configuration to one another in order to generate input signals of the sensors for the control of the actors by means of defined safety reactions. In the following the term configuration is generally used in a simplified manner and should include a programming in dependence on the circumstances.

On a configuration and/or programming of a safety control it is particularly important that it is error-free, since as the processing center will not be certified as secure and in this way cannot be used or can only be used in a limited manner.

For this reason it is the object of the present invention to provide an apparatus and a method of configuring and/or programming a safety control in such a way that an error-free safety control can be generated in a more simple manner.

This object is satisfied by an apparatus for configuring and/or programming a safety control in accordance with claim 1 and by a method in accordance with claim 8.

In accordance with the invention the apparatus for configuring and/or programming a safety control comprises
a display for displaying a program part of the safety control in the form of a block diagram, wherein individual blocks represent program elements;
a memory unit having at least one processing element, in particular a logic link and/or a function and having both safety related as well as non-safety related communication elements which in particular form input signals and output signals; and
a calculation unit for selecting the processing elements and the communication elements in the memory unit and for generating a link of the selected processing element and of the communication elements in the block diagram displayed in the display, is provided,
   wherein the calculation unit is configured in such a way that a communication element characterized as a non-safety related communication element always results at an output side of the processing element on a link of a safety related communication element with a non-safety related communication element which communication elements are present at an input side of the processing element.

Advantageously the processing element is composed of safety related and non-safety related functions and/or of an AND- or OR-logic link. Advantageously the communication element includes safety related and non-safety related input signals and output signals or safety related and non-safety related data, in particular data protocols. It is thereby made possible to configure and to program a safety control in a very flexible manner.

Advantageously, the calculation unit is configured to generate a program controlling the safety control from the block diagram.

Advantageously, the calculation unit is configured to make the communication element characterized as a non-safety related communication element editable and to permit a change of the communication element characterized as a non-safety related communication element into a communication element characterized as a safety related communication element. Advantageously, the calculation unit is configured to permit the change of a communication element characterized as a non-safety related communication element into a communication element characterized as a safety-related communication element only on a confirmation of the change with a statement of grounds. Hereby a manual manipulation of the communication element characterized as a non-safety related communication element can be monitored and documented in a more secure manner in such a way that a tracking of the generation of the safety control is ensured.

Advantageously, the calculation unit comprises a diagnostic means which indicates a position of the processing element at which a safety related communication element and a non-safety related element are present for the first time at the input side so that on a link of a plurality of processing elements and communication elements, the communication element characterized as a non-safety related communication element results as a result. By means of the diagnostic means the element of the safety control can be identified in a simple manner at which a safety related communication element was linked to a non-safety related communication element for the first time so that a communication element characterized as a non-safety related communication element results for a comprehensive, complex safety control of a large processing center which comprises a plurality of different modules linked to one another and possibly so that the manual change of the status of the communication element from a non-safety related communication element into a safety related communication element is checked. Hereby the diagnostic means can be a program element of the safety control or a software tool for the safety control.

The above object is further satisfied in accordance with the invention by a method of configuring and/or programming a safety control which makes available at least one processing element, in particular a logic link and/or a function and both safety related as well as non-safety related communication elements in a memory unit which selects the processing elements and the communication elements from the memory unit; which generates a link of the selected processing element and the communication elements by means of predefined linking rules, wherein a result of the link is always set as a communication element characterized as a non-safety related communication element at an output side of the processing element, when a safety related communication element and a non-safety related communication element are selected on the link at an input side of the processing element.

Advantageously, safety related and non-safety related functions and/or a logic link, in particular AND- or OR-logic links, are made available for the selection as a processing element.

Furthermore, safety related and non-safety related input and output signals or safety related and non-safety related data, in particular data protocols, are advantageously made available for the selection as communication elements.

Advantageously, the communication element characterized as a non-safety related communication element is edited which has resulted as a result of the link between a safety related communication element and a non-safety related communication element and is changed into a communication element characterized as a safety-related communication element. Hereby the change of the communication element characterized as a non-safety related communication element into a communication element characterized as a safety related communication element is advantageously carried out with the statement of a ground for the change only then when the change is confirmed and the statement for the justification of change is documented. Thereby the change of the status of the communication element characterized as non-safety can be securely checked and can be tracked in a simple manner by the documentation of the justification.

Advantageously, with a series of plurality of links, the position of the processing element at which the communication element characterized as a non-safety related communication element resulted is indicated having regard to which a safety related communication element is linked to a non-safety related communication element for the first time at the input side. Thereby an identification of the processing element at which an error could have arisen for the first time can easily be identified so that an error diagnosis can be carried out in a simple manner.

In the following advantageous embodiments of the invention will be explained in detail with reference to the drawing. For this purpose there is shown, partly in a schematic illustration:

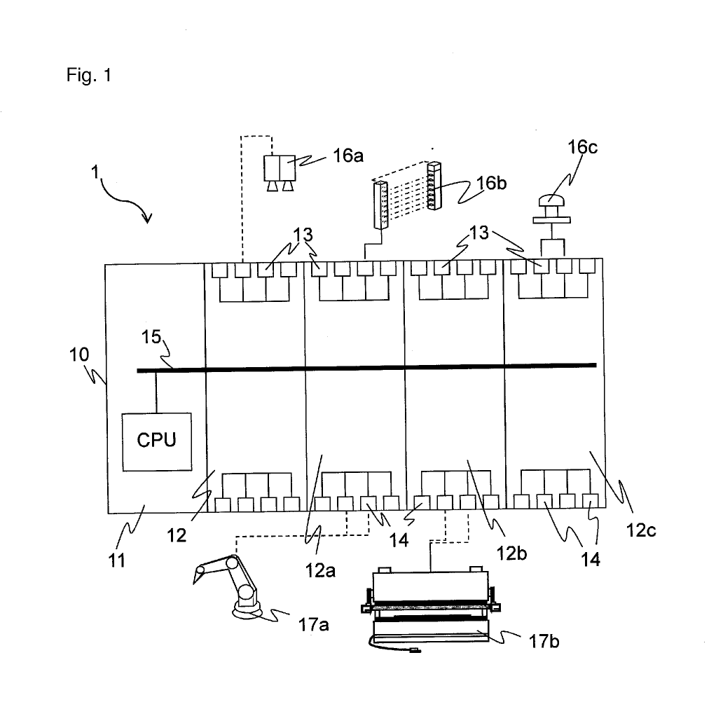

FIG. 1 an illustration of a modular safety control of a processing center having connected sensors and actors which can be configured and/or programmed in accordance with the invention;

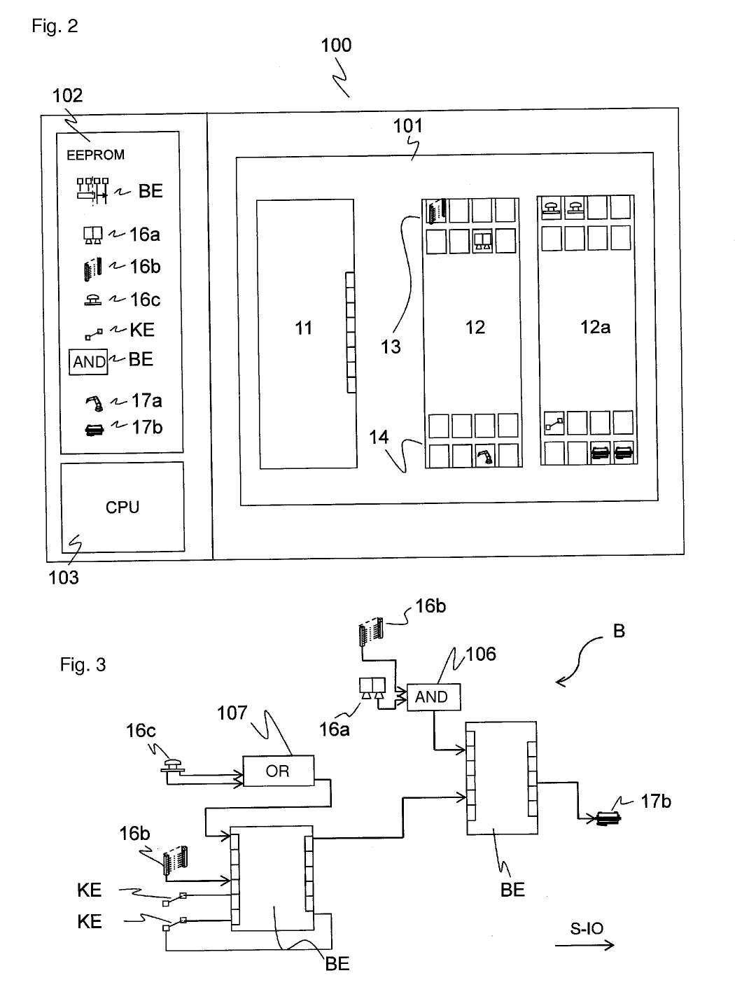

FIG. 2 an illustration of an apparatus for configuring and/or programming the modular safety control in accordance with the invention;

FIG. 3 a purely exemplary logic linking of the sensors and actors for the generation of the program of the safety control;

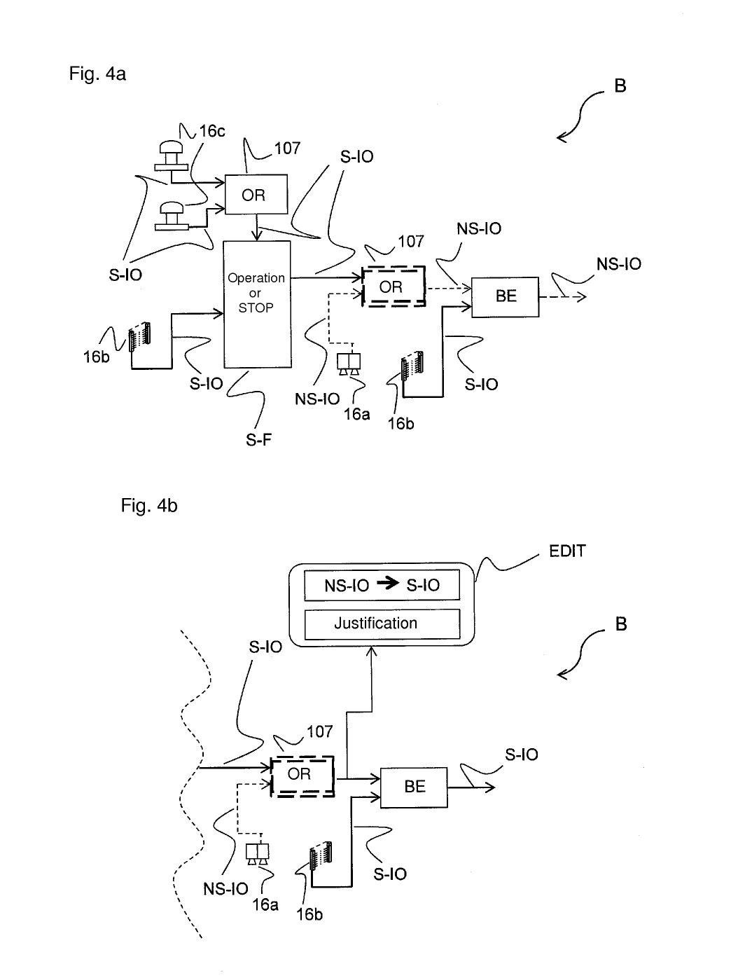

FIG. 4a an illustration of a diagnosis of a chain of linked sensors and actors by means of processing and communication elements in accordance with the invention;

FIG. 4b a diagnosis in accordance with the invention and a change of status of the chain of links of the FIG. 4a in accordance with the invention.

The FIG. 1 schematically shows a processing center 1 which has a safety control 10, sensors and actors. By way of example three sensors which can in particular be a camera 16a, a light grid 16b, an emergency cutoff switch 16c or the like is connected to respective connection modules 12, 12a, 12b, 12c via input connections 13. Two actors, in the form of a robot arm 17a and a punch 17b are connected to the connection modules 12, 12a, 12b, 12c at the output side by means of respectively associated output connections 14 likewise to the safety control 10. The connection modules 12, 12a, 12b, 12c are thus components of the safety control 10 and can vary in their number and in their kind, in particular vary as a safety related or non-safety related.

The connection modules 12, 12a, 12b, 12c preferably have their own calculation units CPU, programmable logic, in particular AND- or OR-logic links 106, 107 or similar digital components for the input evaluation of the signals of the sensors. The sensors transmit their detected states to the connection modules 12, 12a, 12b, 12c where the signals of the sensors are preprocessed (plausibility checks etc.). The output signals of the preprocessing are made available for the actual programming of the safety control 10. The calculation units of the connection modules advantageously communicate with one another via a serial communication connection 15 and are connected to a control module 11 which has the function of a master. Hereby the communication connection 15 can in particular be composed of a data bus which can be based on a serial standard, a field bus standard, such as IO-Link, Profinet, EtherCat or CAN or can also be based on a proprietary standard.

The control 10 monitors the processing center 1, in particular a robot cell of the robot arm 17a and the punch 17b, and on the basis of the detected states of the processing center 1, in particular of situations of danger of the processing center, carries out corresponding safety reactions. Hereby the control module 11 has a calculation unit CPU in the form of a microprocessor or the link, the calculation unit possibly being configured as redundant, and wherein the actual program for control runs on the calculation unit.

For this purpose, processing elements BE are provided at the calculation unit CPU of the control module 11 which operators are in particular configured as safety related and non-safety related functions S-F and/or logic links, in particular AND- or OR-logic links.

Furthermore, so-called communication elements KE are provided amongst which safety related or non-safety related input signals and output signals S-IO, NS-IO or safety related and non-safety related data, in particular data protocols are understood in the framework of this invention.

The processing elements BE process the communication elements KE and transmit corresponding communication elements KE to the actors. This can in particular be a safety directed cutoff or a conveyance of the actors into a secure state.

In order to configure and program the safety control 10 an apparatus 100 for configuring and/or programming the safety control 10 in accordance with the invention is shown in the FIGS. 2 to 4b.

The apparatus 100 has a display 101 at which a program part of the safety control 10 is indicated in the form of a block diagram B, wherein individual blocks represent program elements. By way of example a control module 11 and two connection modules 12, 12a are represented with their respective input and output connections 13, 14, wherein the input and output connections 13, 14 are occupied with the respective sensors and/or actors at the predefined positions.

A memory unit 102 preferably configured as a non-permanent EEPROM memory is provided which comprises at least one processing element BE and both safety related as well as non-safety related communication elements KE.

Furthermore, a calculation unit 103 is provided in the form of a microprocessor CPU or the like with which the processing and communication elements BE, KE can be selected in the memory unit 102. The calculation unit 103 generates a link from the selected processing and communication elements BE, KE in the block diagram B illustrated in the display 101. Hereby the calculation unit 103 always generates a communication element KE characterized as non-safety related at the output side of the processing element BE on a linking of a safety related communication element KE to a non-safety related communication element KE which are present at the input side of the processing element BE.

From the configured block diagram B the calculation unit 103 generates a program with the logic links and/or interconnection of the elements and with corresponding safety reactions that serve the safety control 10 for the control of the processing center 1.

It is thereby ensured that no interference of the safety function of the safety control 10 is present for a common use of safety related and non-safety related processing and/or communication elements BE, KE.

It is advantageous in accordance with the invention to represent the safety related and non-safety related processing and communication elements BE, KE with different colors. Hereby, in particular safety related processing and communication elements BE, KE are characterized with yellow (illustrated as a continuous line in the Figures) and non-safety related processing and communication elements BE, KE are characterized with grey (illustrated as a dotted line in the Figures).

In accordance with the invention the result of a link of a yellow, safety related communication element KE with a grey, non-safety related communication element KE is always represented as a grey communication element KE characterized as a non-safety related communication element so that it is simple to recognize the impact on the safety function of the safety control 10.

An exemplary link of a block diagram B with logical components configured in accordance with the invention is shown in FIG. 3. In this respect two safety related signals S-IO of an emergency cutoff switch 16c are connected to an OR logic link 107. A safety related output signal S-IO for the following first processing element BE is generated from the safety related input signals S-IO. A safety related input signal of a light grid 16b and two safety related communication elements KE are input into the first processing element BE at the input side so that the first processing element BE transmits two safety related output signals S-IO to the next, the second, processing element BE at the output side. A further safety related input signal of a further light grid 16b and a safety related input signal of a camera 16a are connected to an AND logic link 106 from which a safety related output signal S-IO is transmitted to the second processing element BE. The second processing element BE generates and communicates a safety related output signal S-IO, in particular a control signal, to the actor in the form of a punch 17b.

As the link only has safety related elements a completely yellow safety related block diagram B of the safety control 10 is displayed in the display 101 in accordance with the invention.

On a use of a non-safety related communication element KE on the configuration of the safety control 10, as is shown in FIG. 4a, an interference of the safety function of the safety control 10 is identified in accordance with the invention.

In this respect two safety related input signals S-IO from two respective emergency cutoff switches 16c are connected to an exemplary OR logic link 107 from which the two yellow safety related input signals S-IO of the two emergency cutoff switches 16c generates a yellow safety related output signal S-IO and transmits this to the following yellow safety related function S-F. The yellow safety related function S-F receives a further yellow safety related input signal S-IO of a safety related light grid 16b at the input side. The yellow safety related function S-F generates a yellow safety related output signal S-IO from the signals, the output signal serving as a yellow safety related input signal S-IO of a subsequent yellow safety related OR logic link 107. The yellow safety related OR logic link 107 additionally receives a grey non-safety related input signal NS-IO of a non-safety related camera 16a so that in accordance with the invention the output signal of the yellow safety related OR logic link 107 takes effect as a grey signal characterized as a non-safety related signal NS-IO and is correspondingly communicated as such to the following yellow safety related processing element BE.

At this point in time the safety related OR logic link is characterized as non-safety related and the subsequent chain of links is illustrated as no longer safety related.

The subsequent yellow safety related processing element BE receives an additional yellow safety related input signal S-IO from a further safety related light grid 16b and the grey signal characterized as a non-safety related signal NS-IO from the OR logic link 107. Likewise a grey signal characterized as a non-safety related signal NS-IO as an output signal the processing element BE is generated so that the complete safety control 10 takes effect as non-safety related.

The safety control 10 generated in this way, which is characterized as non-safety related in the display 101 starting from the OR logic link 107, can advantageously be checked and possibly be transformed into a safety related control in accordance with the invention.

A check and transformation in accordance with the invention is shown in FIG. 4b. The illustrated block diagram corresponds to a section of the FIG. 4a, wherein the OR logic link 107 is identified and characterized after the diagnosis as the element of the chain of links at which for the first time a grey non-safety related input signal NS-IO was linked to a yellow safety related input signal S-IO so that the safety function of the overall safety control 10 is impaired with and is no longer characterized as safety related.

The apparatus 100 in accordance with the invention enables an operator to edit the grey output signal NS-IO characterized as a non-safety related output signal of the OR logic link 107 and to transform the output signal into a safety related output signal S-IO by means of the processing window EDIT, when the output signal is allowed to take effect as a safety related output signal, e.g. in the case of a use of a safety related camera 16a instead of as previously assumed a non-safety related camera 16a so that both input signals of the OR logic link 107 are actually safety related signals S-IO. In this respect this justification for the safety relevant change of the output signal NS-IO->S-IO has to be input and confirmed.

On the transformation the subsequent processing element BE instead of a safety related and a non-safety related input signal S-IO, NS-IO receives two safety related input signals S-IO, so that the output signal of the complete chain of links and in this way the configured safety control (10) again represents a safety related output signal S-IO.

After checking the chain of links a safety related program can be generated and implemented in the safety control 10 so that the safety control 10 can be made available to the processing center 1.

In accordance with the invention a possible safety relevant error configuration and programing of the safety control 10 can be recognized and remedied in a simple kind and manner.

### LIST OF REFERENCE NUMERALS

1 processing center
10 safety control
11 control module
12 connection module
13 input connections
14 output connections
15 communication connection
16a camera
16b light grid
16c emergency cutoff switch
17a robot
17b punch
100 apparatus for configuring and/or programming
101 display
102 memory unit
103 calculation unit
106 AND logic link
107 OR logic link
S-IO safety related input and output signals
NS-IO non-safety related input and output signals
S-F safety related function
B block diagram
BE processing element
KE communication element
EDIT processing window

What is claimed is:

1. An apparatus (100) for configuring and/or programming a safety control (10), comprising:
a display (101) for displaying a program part of the safety control (10) in the form of a block diagram (B), wherein individual blocks represent program elements;
a memory unit (102) having at least one processing element (BE) and having both safety related as well as non-safety related communication elements (KE); and
a calculation unit (103) for selecting the processing elements (BE) and the communication elements (KE) in the memory unit (3) and for generating a link of the selected processing element (BE) and of the communication element (KE) in the block diagram (B) displayed in the display (101), wherein the calculation unit (103) is configured in such a way that a communication element (KE) characterized as a non-safety related communication element always results at an output side of the processing element (BE) on a link of a safety related communication element (KE) to a non-safety related communication element (KE) which communication elements are present at an input side of the processing element (BE).

2. The apparatus in accordance with claim 1, wherein the at least one processing element is a logic link and/or a function.

3. The apparatus in accordance with claim 1, wherein the safety related as well as non-safety related communication elements (KE) form input signals and output signals.

4. The apparatus in accordance with claim 1, wherein the processing element (BE) is composed of safety related and non-safety related functions (S-F) and/or of a logic link.

5. The apparatus in accordance with claim 1, wherein the communication element (KE) includes safety related and non-safety related input and output signals (S-IO, NS-IO) or safety related and non-safety related data.

6. The apparatus in accordance with claim 6, wherein the data comprises data protocols.

7. The apparatus in accordance with claim 1, wherein the calculation unit (103) is configured to generate a program controlling the safety control (10) from the block diagram (B).

8. The apparatus in accordance with claim 1, wherein the calculation unit (103) is configured to make the communication element (KE) characterized as a non-safety related communication element editable and to permit a change of the communication element (KE) characterized as a non-safety related communication element into a communication element (KE) characterized as a safety related communication element.

9. The apparatus in accordance with claim 8, wherein the calculation unit (103) is configured to permit the change of the communication element (KE) characterized as a non-safety related (KE) communication element into a communication element (KE) characterized as a safety related communication element only on a confirmation of the change with a statement of grounds.

10. The apparatus in accordance with claim 1, wherein the calculation unit (103) has a diagnostic means which indicates a position of the processing element (BE) at which a safety related communication element (KE) and a non-safety related communication element (KE) are present for the first time at the input side, so that on a link of a plurality of processing elements (BE) and communication elements (KE) the communication element (KE) characterized as a non-safety related communication element results as a result.

11. A method of configuring and/or programming a safety control (10) comprising the steps of:
providing at least one processing element (BE); and both safety related as well as non-safety related communication elements (KE) in a memory unit (102);
selecting the processing elements (BE) and communication elements (BE) from the memory unit (102);
generating a link of the selected processing element (BE) and communication elements (KE) by means of predefined linking rules;
wherein a result of the link is always set as a communication element (KE) characterized as a non-safety related communication element at an output side of the processing elements (BE) when a safety related communication element (KE) and a communication element (KE) are selected on the link at an input side of the processing element (BE).

12. The method in accordance with claim 11, wherein the at least one processing element comprises one of a logic link and a function.

13. The method in accordance with claim 11, wherein safety related and non-safety related functions (S-F) and/or a logic link are made available for a selection of the processing element (BE).

14. The method in accordance with claim 13, wherein the logic link comprises one of an AND-logic link and an OR-logic link (106, 107).

15. The method in accordance with claim 11, wherein safety related and non-safety related input and output signals (S-IO, NS-IO) or safety related and non-safety related data are made available for the selection as communication elements (KE).

16. The method in accordance with claim 15, wherein the data comprises data protocols.

17. The method in accordance with claim 11, comprising the steps of
editing the communication element (KE) characterized as a non-safety related communication element which has resulted as a result of the link between a safety related communication element (KE) and a non-safety related communication element (KE); and
changing the communication element (KE) characterized as a non-safety related communication element into a communication element (KE) characterized as a safety related communication element.

18. The method in accordance with claim 11, comprising the steps of:
confirming the change of the communication element (KE) characterized as a non-safety related communication element into a communication element (KE) characterized as a safety related communication element with the statement of a ground for the change; and
carrying out and documenting the justification, as well as the statement of justification for the change.

19. The method in accordance with claim 11, wherein, with a series of plurality of links, the position of the processing element (BE) at which the communication element (KE) characterized as a non-safety related communication element has resulted is indicated having regard to which a safety related communication element (KE) is linked to a non-safety related communication element (KE) for the first time at an input side.
